(19) United States
(12) Patent Application Publication
(10) Pub. No.: US 2008/0136201 A1
(43) Pub. Date: Jun. 12, 2008

(54) Portable pet litter and refuse picking device

(76) Inventor: Jichang Dong, Ningbo (CN)

Correspondence Address: Triple Three International Trade LLC, 21 Crabapple Road, West Hartford, CT, 06117, US

(21) Appl. No.: 11/998,752

(22) Filed: Dec. 3, 2007

(30) Foreign Application Priority Data
Nov. 22, 2006 (CN) ZL200620140171.5
Nov. 22, 2006 (CN) ZL200630156620.0

(51) Int. Cl. A01K 29/00

(52) U.S. Cl. 294/1.3

(57) ABSTRACT

Portable pet litter and refuse pick device provides sanitarily and single-handedly cleaning up after pet. Its features include hand grip with a trigger, straight hollow pipe and picking mechanical structure. Picking mechanical structure includes: the first and second piece of collection, hollow pipe pulling cable, reset spring and its guidance. One end of the guidance piece sets against joint part of the first and second collection pieces. The other end is connected to pulling cable. In no stress state, the two collection pieces are natural open; in pulling cable stress state, the two collection pieces can turn to a closure around a fulcrum. This invention has advantages: (1). By pulling elongate cable to operate the device, this reduces the possibility of contamination by users to touch pet litter and refuse. (2). Litter and refuse can be reached without any bending. (3). User-friendly portable collection structure provides convenience to pet owners.

### CROSS-REFERENCE

Int. Cl. Utility model patent ZL03242950.9 (publication No. CN2613141.Y), China
Int. Cl. Utility Patent ZL03238461.0, China
U.S. Cl. 56015321 by Allen Simon
U.S. Pat. No. 7,178,843B2 by Barry Askinasi
Int. Cl. This invention was granted by Chinese Patent ZL 200620140171.5 and ZL 200630156620.0

### BACKGROUND OF THE INVENTION

Litter and refuse generated by pets has posed a lot of inconvenience to pet owners. Immediate retrieve pet refuse is essential to keep clean living environment, and prevent potential bacteria breeding. Generally, a small shovel, small brooms, disposable plastic bags are usually used to perform the task of cleaning up after pets.

In China, utility model patent ZL03242950.9 (publication No. CN2613141.Y) provides litter and refuse clean-up device, which includes a shovel body, grip, scoop and pocket. The invention of a shovel with pocket to perform waste collection task had made progress and provided somewhat convenience to users. However, because of inherent shovel structural limitations, the user has to bend to operate the device. In addition, the heavier weight of the shovel made the operation not particularly comfortable for a user. The possibility of contamination to users is still larger.

Chinese Utility Patent ZL03238461.0 published another pet litter and refuse retrieve device. The patent provided the device through handler movement to coordinate lids open and closure at the other end and in this way to complete excreta collection. This device allows a user to operate the device as the user stands straight, but its overall complexity of the structure, it makes production process not convenient and high production costs.

US patent 56015321 and U.S. Pat. No. 7,178,843B2 published Litter and refuse retrieval device invented by Allen Simon and Barry Askinasi, respectively.

### SUMMARY OF THE INVENTION

The objective of the present invention is to provide the simplified structure and convenient operation portable device to perform pets letter and refuse retrieval task.

The other objective of this invention is to provide a reliable device at reasonable production cost.

This invention is to simplify the structure by the following design: The device features
Grip, with an appropriate trigger by finger;
Straight hollow tubes;
Collection pieces, including the first collection piece is composed of the first collecting piece and its rotation component;
With the aforementioned first collection piece, the corresponding second collection pieces has the second rotation component and the second collection piece. A disposable detachable plastic bag is attached to the second collection piece. The opening side of the bag set against the first collection piece.
Pulling cable in the aforementioned straight hollow tube, one end of the cable connects to rotation joint between the first and second collection. The other end connects to the aforementioned trigger;
Reset spring;
Guidance tube surrounding the reset spring, inside the guidance tube a blocker to stop the spring movement as needed. The tube set against the first and second collection pieces and the other side connects to hollow tube.

If no stress, the first and second collection pieces are natural open. When pulling cable, the first and second collection pieces move to close status by turning around a fulcrum closure. In bottom of the first collection piece has an extended edge functioning as a shovel to pick up pet litter and refuse. This design enables pet litter and refuse to be collected thoroughly and conveniently.

Connection among guidance tube, the first and second collection pieces is as follows: the first and second rotation components have convex pins, which fit into the holes on guidance tube.

Connection between pulling cable and collection pieces is as follows: the pin at the end of pulling cable fits into kidney shaped hole on the first and second rotation components. So the pin can move freely in either direction along the hole.

The connection of the second collection piece and the detachable plastic bag is as follows: there is a circular cavity on the second collection piece surface. A robber band or similar rope wraps the plastic bags around the circular cavity. Holes on the collection pieces are to fix the rope. The rope is flexible and fixed at one end in the hole and the other end is fixed at a hook in the other hole. Of course, technology can also be used in existing common from disposal methods, such as connecting rod ends by alphabetical hook and so on.

In comparison with the existing technology, the advantages of this invention are: By pulling elongate cable to operate the device, this would reduce the possibility of contamination by users. The device is user-friendly, as long as the user presses the trigger with finger then the pet litter and refuse could be retrieved into a plastic bag immediately. The simplified structure of the device do not requirement complicated production procedures. The production cost could be reduced significantly. The extended edge of the first collection piece facilities picking pet litter and refuse completely and no waste left after clean up. It enables collect litter and refuse into plastic bag more precisely without difficulty to pick all litter and refuse at no time. Connectivity in plastic bag and the second collection piece allow quick detachment of the plastic bag when it is full. Further, it is easy for attached a new bag to the collection piece. With the holes and hooks, the bag can be firmly fixed on the collection piece.

### DESCRIPTION OF FIGURES

FIG. 1: Illustration of the structure diagram.

FIG. 2: The enlarged view of the Part A.

FIG. 3: Three-dimensional decomposition view.

FIG. 4: Illustration of the collection pieces are natural open position.

FIG. 5: Illustration of the closure status of the collection pieces after pulling cable is triggered.

### DETAILED DESCRIPTION OF THE INVENTION

With the illustration of the attached figures, the following is the detailed description of the present invention utilization.

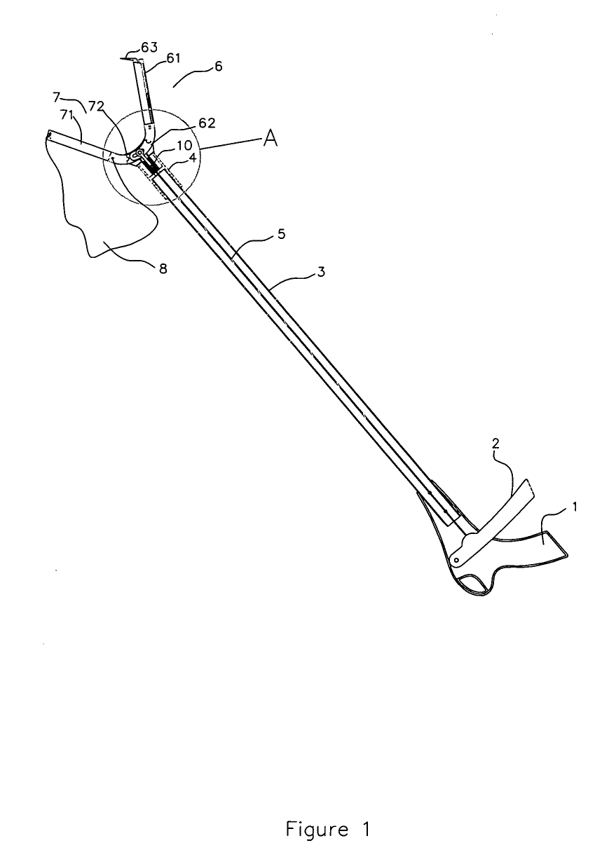

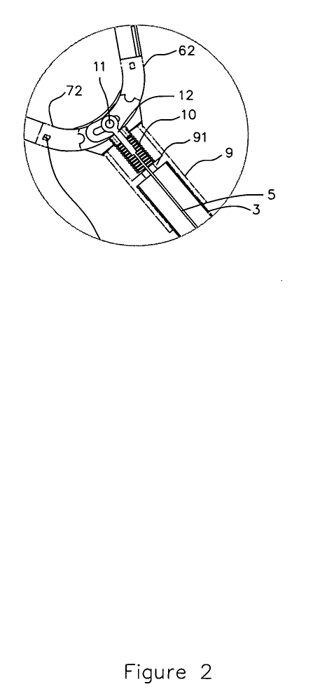

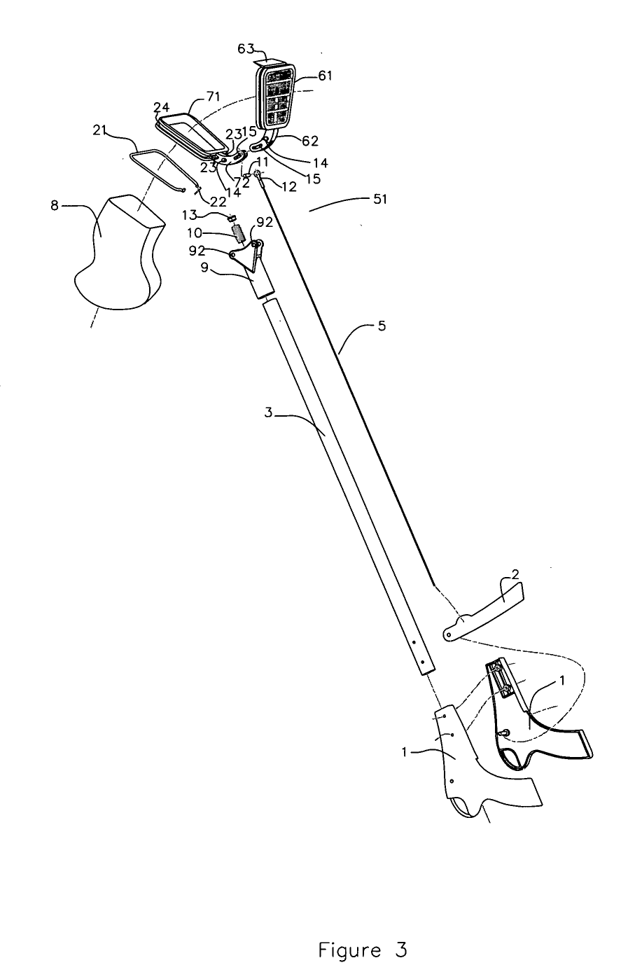

Referring to FIG. 1 to 3, the device has components of a grip 1, hollow tube 3 and the collection pieces 51, a finger trigger 2 on the grip 1.

Collection pieces 51 include the first collection piece 6, the second collection piece 7, pulling cable 5 in the hollow tube 3, reset spring 10 and guidance tube 9 surrounding the spring 10.

The first collection piece 6 consist of the first collection plate 61, the first rotation component 62 and extended edge 63 at the bottom of collection plate 61. The second collection piece 7 consist of the second collection plate 71 and the second rotation component 72, a detachable plastic bag 8 on the second collection plate 71, the opening side of bag 8 face to the first collection plate 61. Pulling cable 5 connects one end to joint of the first collection piece 6 and the second collection piece 7, the other end of the cable 5 is connected to the trigger 2. A blocker 91 in Guidance tube 9 is to stop bounce of the reset spring 10, one end of guidance tube 9 set against the joint of the first collection piece 6 and the second collection piece 7, other end of the guidance tube 9 connect to hollow tube 3. Of these, both the first rotation component 62 and the second rotation component 72 have convex pins 14, the pins 14 fit into hole 92 on guidance tube 9. At the end of pulling cable 5, there is a pin 11, which fits into kidney shaped holes 15 on the first rotation component 62 and the second rotation component 72. The pin 11 is able to move freely in both holes 15 in either direction. Pulling cable go through reset spring 10. A rubber pad 13 set on the top of the reset spring 10. The first rotation component 62 and the second rotation component 72 are connected together through pin 11 and kidney shaped hole 15. At the top of pulling cable 5 also connection part 12 with a hole, the connection part 12 connects the hole to the pin 11.

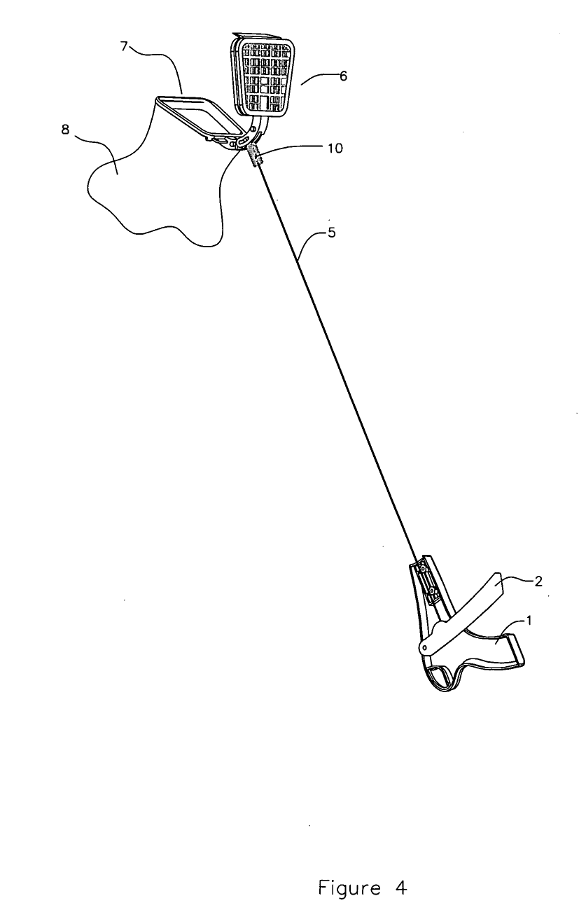

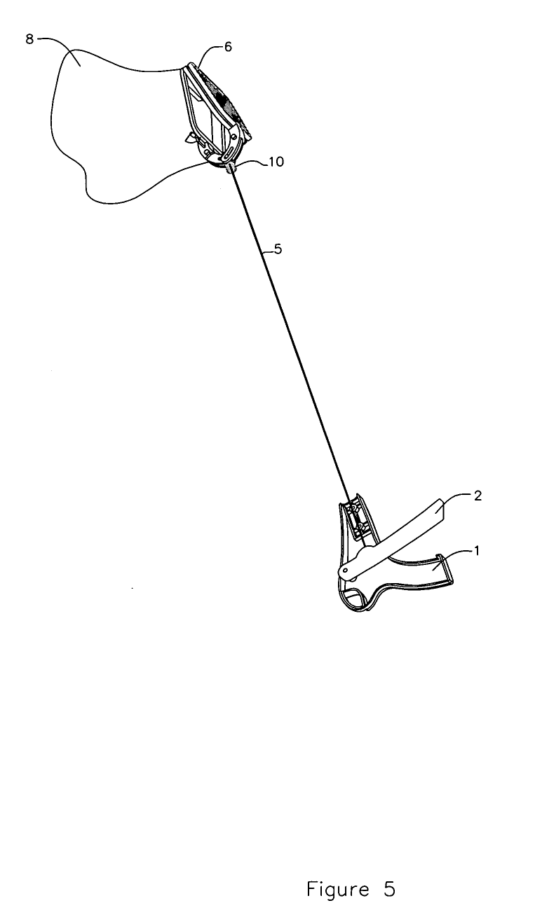

As illustrated in FIG. 4 and FIG. 5, if no stress, the first collection piece 6 and the second collection piece 7 are natural open. When pressing trigger 2 with a finger, pulling cable 5 is moving up, the first collection pieces 6 and the second collection piece 7 are turning to closure status. By closing two collection plates 61 & 71, the pet litter and refuse are collected into plastic bag 8.

On the surface of the second collection plate 71 there are circular cavity 24 and a pair of holes 23 to fix flexible rope 21. The rope 21 surrounds the plastic bag 8 by one end fixed at hole 23 and the other end with hook 22 so the rope 21 can be taken off after it wrap in circular cavity 24.

When the bag 8 is filled with excrement, take off hook 22, the rope 21 will be loosed and the bag 8 can be taken off from the second collection plate 71. Following the reversing operations, a new empty plastic bag 8 can be installed quickly.

1. The device features
Grip, with an appropriate trigger by finger;
Straight hollow tubes;
Collection pieces, including
The first collection piece is composed of the first collecting piece and its rotation component;
With the aforementioned first collection piece, the corresponding second collection pieces has the second rotation component and the second collection piece. A disposable detachable plastic bag is attached to the second collection piece. The opening side of the bag set against the first collection piece.
Pulling cable in the aforementioned straight hollow tube, one end of the cable connects to rotation joint between the first and second collection. The other end connects to the aforementioned trigger;
Reset spring;
Guidance tube surrounding the reset spring, inside the guidance tube a blocker to stop the spring movement as needed. The tube set against the first and second collection pieces and the other side connects to hollow tube.
If no stress, the first and second collection pieces are natural open. When pulling cable, the first and second of the collection pieces move to close status by turning around a fulcrum closure.

2. In bottom of the first collection piece has an extended edge functioning as a shovel to pick up pet litter and refuse. This design enables pet litter and refuse to be collected thoroughly and conveniently.

3. Connection among guidance tube, the first and second collection pieces is as follows: the first and second rotation components have convex pins, which fit into the holes on guidance tube.

4. Connection between pulling cable and collection pieces is as follows: the pin at the end of pulling cable fits into kidney shaped hole on the first and second rotation components. So the pin can move freely in either direction along the hole.

5. The connection of the second collection piece and the detachable plastic bag is as follows: there is a circular cavity on the second collection piece surface. A robber band or similar rope wraps the plastic bags around the circular cavity.

6. Holes on the collection pieces are to fix the rope.

7. The rope is flexible and fixed at one end in the hole and the other end is fixed at a hook in the other hole. Of course, technology can also be used in existing common from disposal methods, such as connecting rod ends by alphabetical hook and so on.
